(19) United States
(12) Patent Application Publication
(10) Pub. No.: US 2003/0122379 A1
(43) Pub. Date: Jul. 3, 2003

(54) Reform energy from open road motion

(76) Inventor: Robert Woods, Richmond, CA (US)

Correspondence Address: ROBERT WOODS, 85 BAYSIDE COURT, RICHMOND, CA, 94804, US

(21) Appl. No.: 10/029,924

(22) Filed: Dec. 31, 2001

(51) Int. Cl. H02P 9/04; F03D 9/00

(52) U.S. Cl. 290/55

(57) ABSTRACT

The nature of RERFORM Energy System invention captures the wind energy that is produce from vehicular motion on highways. This captured wind energy is recycled inside a wind cylinder assembly (wind tunnel) to produce electricity. This patent lacks any compatible system for comparison, because vehicular road energy has never been realize or produce as a public benefit as a renewable energy source.

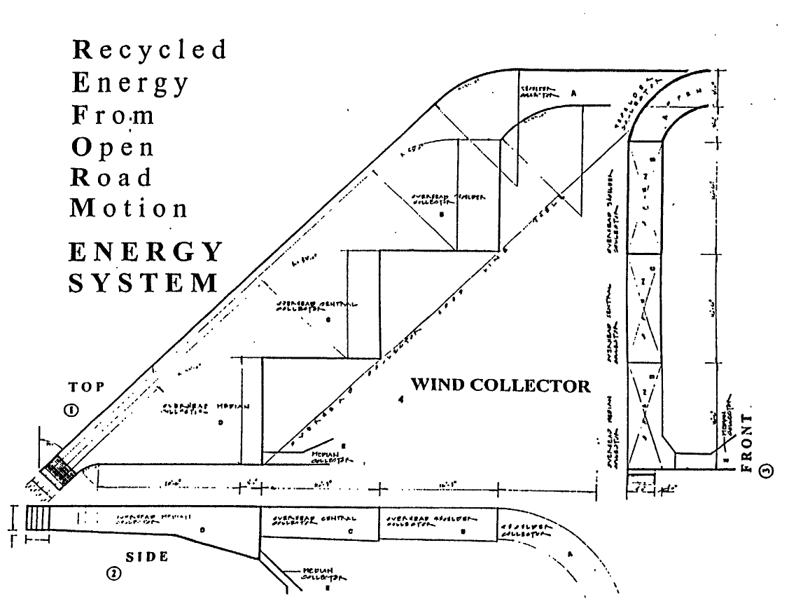

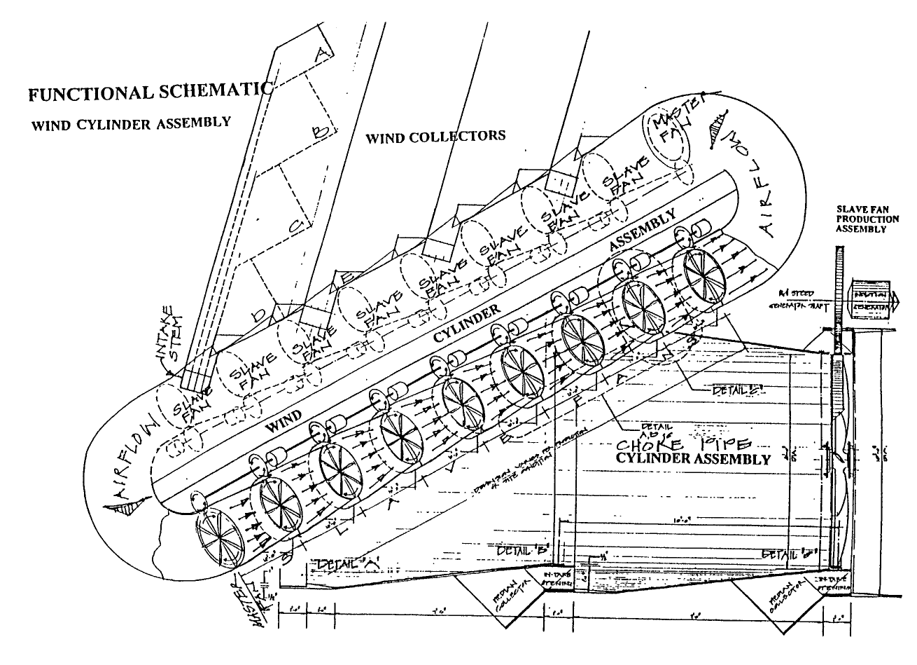

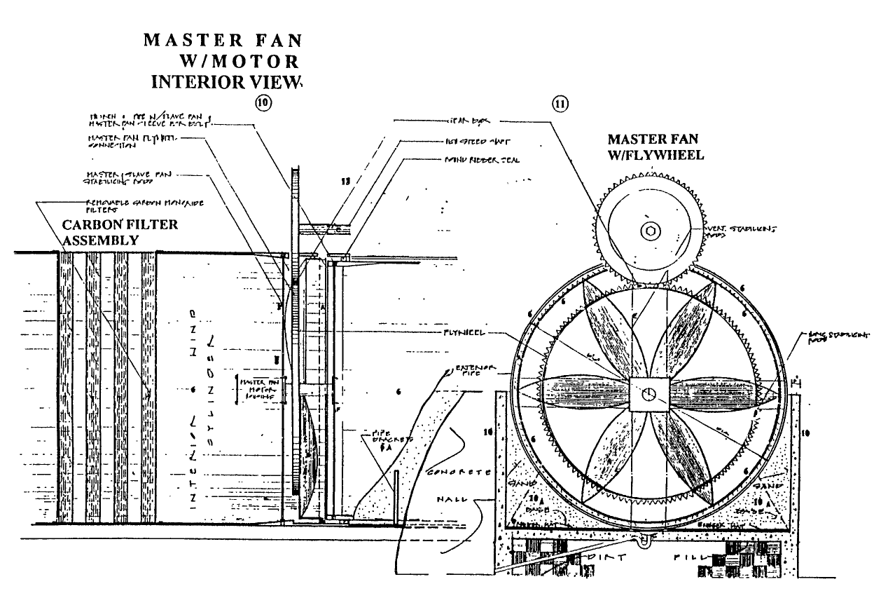

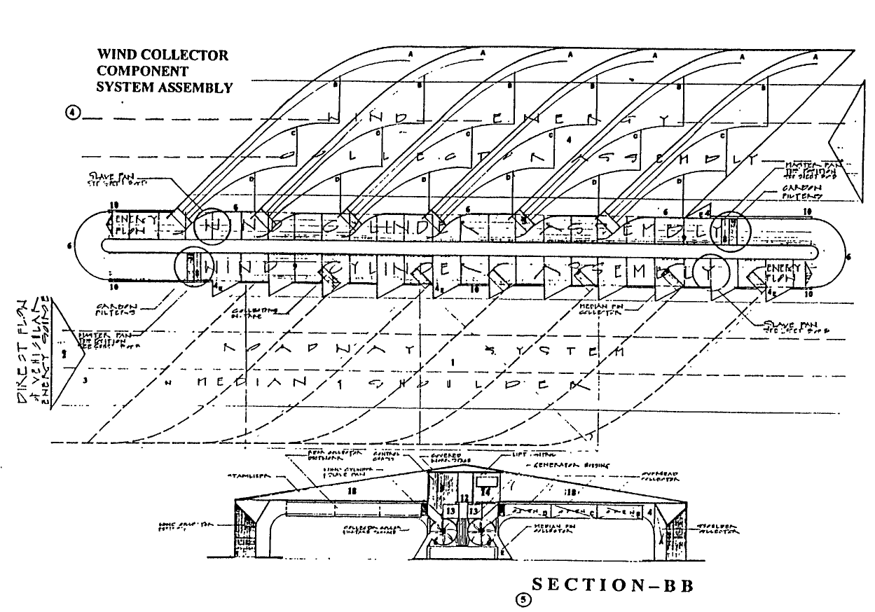

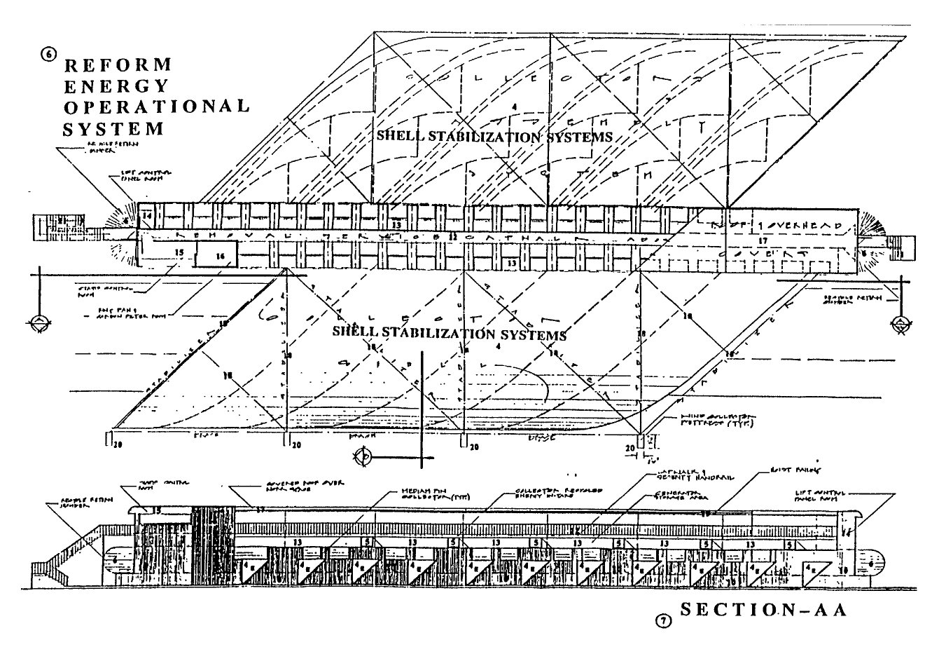

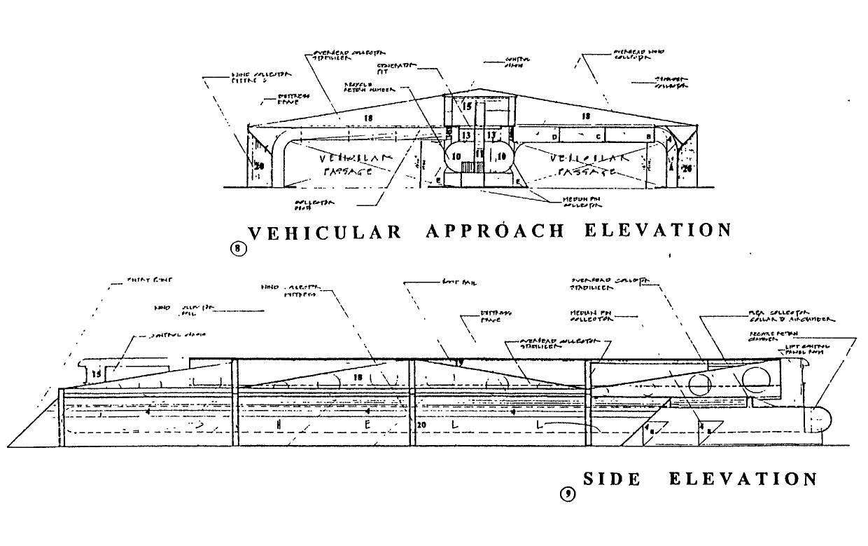

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO MICROFICHE APPENDIX

Not Applicable.

### BACKGROUND OF THE INVENTION

REFORM Energy Systems has been issued a confirmation no. 3196 as a Provisional Patent that was filed Mar. 22, 2001 with The Department of Commerce, Patent and Trademark Division. This invention is a Renewable Energy Source, being filed as a Non-Provisional Utility Patent for the purpose of producing electricity using the winds produce from vehicular motion on America's freeways as its energy source.

The profile of the (REFORM Energy System) invention has no physical resemblance to any other electrical producing utility agent. The REFORM Energy System invention is unique discovery due to its ability to utilize existing energy being wasted on America's freeways, Reform Energy Systems captures this freeway energy and recycles its power into electricity.

REFORM Energy is defined as, (R)ecycled (E)nergy (F)rom (O)pen (R)oad (M)otion. REFORM Energy Systems was developed from the idea of capturing the wind energy produced by vehicular motion on America(s) freeway. To The Department of Commerce, Patent and Trademark Division knowledge, there are no existing Utility Manufacturers that produces electricity by utilizing vehicular motion from America's freeways. America's freeways could potentially be the second largest producer of wind, besides Mother Nature, which could be very elusive, unpredictable, and untamed in its nature form. However, this invention could easily control America's steady source freeways energy due to the order of our freeway system. The inventor views freeway energy as an untapped commodity with tremendous potential as a public benefit. By capturing this vehicular wind energy and recycling it into a public benefit could change the way Americans review its entire eco-system and reduce its dependence on foreign petroleum products.

Utilizing windmill turbines as an energy source to produce electricity becomes an exercise in site selection, wait and see if mother nature's winds will come calling. Due to the changing winds, the windmill turbine as a renewable energy did not solve the problem as a continuous energy provider. Saturating the area with many turbines became the solution to the problem to capture open range energy. The turbine windmill would be the closest form of energy production to REFORM Energy Systems as it is known today. REFORM Energy System is a constant source of freeway motion and energy verses waiting for mother nature wind's to come calling to spur maybe five turbine out of fifty.

### SUMMARY OF THE INVENTION

The Inventor's REFORM Energy System will ignite new electrical markets and develop a new economy by recycling vehicular energy into electricity as if it was a plastic bottle or an aluminum can or any other recyclable commodity. The usage of REFORM Energy Systems can reduce the usage of fossil fuel, preserve our environment and reduce air pollution. This patent alone will revolutionize the electrical industry by recycling road motion into electricity without spending a lot of money to produce once the facilities has been constructed on America's freeway.

### BRIEF DESCRIPTION OF THE VARIOUS VIEWS OF THE DRAWING

There are six (6) sheets of drawings describing the REFORM Energy System for visual assistant. The sheets are as listed:

SHEET 1 of 6 WIND COLLECTOR ASSEMBLY SYSTEM

1. TOP VIEW; showing the arrangement of the wind collectors

2. SIDE VIEW; showing the arrangement of the wind collectors

3. FRONT VIEW; showing the arrangement of the wind collector

SHEET 2 of 6 FUNCTIONAL & WIND CYLINDER ASSEMBLY

4. FUNCTIONAL SCHEMATIC, illustrates the relationship of the components associated with freeway movement, the wind collectors and the wind cylinder assembly.

5. WIND CYLINDER ASSEMBLY, Demonstrates the interior action of the fans to activate the generators.

6. CYLINDER ASSEMBLY DETAIL, The slave fan production assembly, Choke Pipe detail between fans with attached lower median collector.

7.

SHEET 3 of 6 MASTER FAN W/FLY WHEEL & CARBON FILTER ASSEMBLY

8. MASTER FAN ASSEMBLY; demonstrating interior wind Cylinder operations.

9. MASTER FAN W/MOTOR HOUSING showing INTERIOR SIDE VIEW. FRONT VIEW; showing FLYWHEEL and GENERATOR GEAR BOX connected to the GENERATOR.

SHEET 4 of 6 WIND COLLECTOR ASSEMBLY

10. SECTION-BB, shows a cross-section cut across the freeway.

11. Illustration of wind collectors assembled on the freeway, with directional flows.

SHEET 5 of 6 OPERATIONAL SYSTEM

12. Shows the upper level work space, collector location & the collector shell with stabilizers location

13. SECTION-AA; is a cross-section showing the entire length of Processing Median Operation, upper and lower functions.

SHEET 6 of 6 PROJECT ELEVATION

14. VEHICULAR APPROACH ELEVATION; showing Front View on the right & Rear View on the left in the vehicular passage area.

15. SIDE ELEVATION; showing the exterior shell & Shell Stabilizer with Concrete Buttress.

This concludes the brief description of the drawings that is found in this Non-Provisional Application for REFORM Energy Systems.

### DETAILED DESCRIPTION OF INVENTION

The REFORM Energy System's functional and operational schematics are illustrated. The list below represents the sequential process in producing electricity from vehicular motion:

1. Freeway: (the host) were vehicles travel in opposite directions within the REFORM Energy Station. Vehicular wind motion is produce and eventually converted into electricity.

2. Vehicular Motion: is needed to produce the wind energy (vortex) needed to capture and eventually converted into energy. The vehicular motion is must be generated on both sides of the freeway. In addition, vehicles should travel at the posted speed limits.

3. Vehicular Generated Wind (Vortex): This wind movement is generated from the vehicular motion as the vehicles pass through the REFORM Energy Station. This wind energy is captured and converted into electrical energy via the generators.

4. Wind Collectors Shell: are a series of various types of wind collectors for the purpose of capturing the vehicular wind at different locations within the REFORM Energy Tunnel Collectors. The wind collectors are arranged in a forty-five degree angle (45°) from the right shoulder of the freeway to the left median. The wind collectors are also arranged in a staggered manner. The ducts act as a transporting agent for the purpose of delivering the wind to the wind cylinder assembly. The duct size is reduced to help the wind to increase its speed (initial duct size: 5 ft.×20 ft. and final duct size: 4 ft.×4 ft.). The Wind Collector Shell is comprised of various types of wind collectors.

a. Shoulder Collector: wind collector located (extreme right-side of the road) closest to the shoulder of the freeway. The purpose of the collector is to collect the vehicular generated wind at the shoulder of the freeway.

b. Overhead Shoulder Collector: wind collector located above the road of the shoulder. The purpose of the collector is to collect vehicular generated wind above the shoulder of the freeway.

c. Overhead Central Collector: wind collector located above the central portion of the freeway for the purpose of capturing the vehicular generated wind.

d. Overhead Median Collector: wind collector located above the median of the freeway for the purpose of capturing the vehicular generated wind above the median of the freeway. (similar to the overhead shoulder collector)

e. Median Collector: wind collector is located at the median of the freeway. The purpose of the collector is to collect vehicular generated wind. (similar to the shoulder collector)

5. Intake Valve:(4 ft.×4 ft.) a valve connected to the wind cylinder assembly that connects the wind collector system to the wind cylinder assembly. The purpose of the intake valve is to thrust the captured wind energy into the wind cylinder assembly to assist the slave fan to generate power.

6. Wind Cylinder Assembly: is a ten feet diameter (10 ft.) tube with a smooth interior finish to minimize the friction of the collected wind. The Wind Cylinder Assembly is a tube shaped unit located on both sides of the freeway. Each wind cylinder assembly, is connected by two U-shape connectors for the purpose of making a wind tunnel system. The circular operation of the wind cylinder assembly works as a wind tunnel. The REFORM Energy collected from the Wind Collectors is thrust into the wind cylinder assembly at a forty-five degree angle (45°). The master fan along with the wind energy collected work together for the purpose of propelling the blades to the slave fans. As a result, the fan blades rotate the shaft to the generators, thus supplying electricity to the electrical grids. The wind cylinder assembly housing consist of:

a. Carbon Filters: captures the carbon particles from the exhaust of the vehicles traveling through the REFORM Energy station (#7).

b. Master Fan: electrically powered fan that helps to propel the newly collected wind energy from the wind cylinder assembly (#8).

c. Slave Fan: is a wind propelled fan that is connected to its individual generator by a shaft for the purpose of supplying electricity to the electrical grid (#9).

(See Sheet 2 of 6; Functional Schematic)

d. Hatch: located underneath the removable catwalk and below the generators housing unit. The position of the hatch is between nine and eleven o'clock or one and three o'clock on the wind cylinder assembly. The hatches are air tight entries were operators could conduct repairs and maintenance services to the equipment.

7. Carbon Filters: are located inside the wind cylinder assembly, however below the floor inside of the chassis control room for daily monitoring and carbon filter replacement. The carbon filters are strategically located behind the master fan (see 8a below) for the purpose of cleaning the captured wind energy carbon monoxide before it escapes into the atmosphere.

8. Master Fan: (sheet 3 of 6) is the only electrical moving device within the REFORM Energy System The master fan is located between the carbon filters and behind the slave fan. The purpose of the master fans are to:

a. Pull the captured carbon monoxide air from the wind cylinder assembly from the adjacent wind cylinder assembly. Thus, expelling cleaner air throughout the REFORM Energy System.

b. The alignment of the master fan behind the slave fans inside the wind controlled cylinder produces a “domino effect” onto each slave fan. As a result, to the “domino effect” of the wind energy produced by the master fan, wind energy is passed through to each slave fan.

c. Assists the wind collection process by creating a wind tunnel draft by pulling the captured wind energy from the wind collectors.

d. The gearbox that assist the slave fan and generator in moving the generator shaft to produce electricity. (see sheet 2 & 5 of 6)

9. Slave Fan: is a non-electrical unit, its primary function is to begin the process of converting the vehicular wind energy from the wind collectors and the master fans generated wind energy into electricity. The slave fans are station ten feet (10 ft.) apart within the wind cylinder assembly. In addition, the slave fans are propelled by the incoming wind from the wind collectors (see sheet 2 of 6; Functional Schematic, #11 front interior view).

a. The slave fan's blades are set in reverse to allow the continuous passage of wind energy from one slave fan to another slave fan.

b. The tips of the Slave Fan Blades are attached to a flywheel that engages the generator gearbox.

c. The generator gearbox is attached to a shaft that is connected to the each slave fan. As the slave fan blades rotate, the shaft connected to the generator gearbox rotates, thus supplying power to the electrical grids.

10. Concrete Reinforced Wall: is a six-inch (6 in.) concrete wall that protects the wind cylinder assembly and provides structural support for the operational assembly above the wind cylinder assembly.

a. Sand Base: used between the exterior of the wind cylinder assembly and the concrete reinforced wall to provide a soft bedding to eliminate noise pollution.

b. Perforated One Inch (1 in.) Rubber Mate: is located between the top of the four-inch (4 in.) thick concrete platform and the wind cylinder assembly bracket.

c. Platform Drain: is located below the four-inch platform and at the center for the purpose of drainage.

11. Exterior Stair Casing: located at the front of each approach to the station. The purpose of the stairs, are to access the operations of the REFORM Energy station.

12. Removable Cat Walk: is located above the wind cylinder assembly. The catwalk allows an operator to monitor the generators and to make any repairs.

13. Generator Cabinets: are located in the generator pit, which is located on both sides of the catwalk. The generator cabinets can be monitored from above, on the catwalk.

a. In addition, another opening is located in the interior space below the removable catwalk. The purpose of this space is used to run electrical cables between the generators and the control chassis.

b. The purpose of the electrical cables from the generators to the control chassis is to record the performance of each generator. This will allow the operator to make manual or remote adjustments to the intake of collected wind energy as needed.

14. Lift Control Panel Room: is an exterior operation to assist the workers/operators in repairing or replacing various parts of the operation.

15. Chassis Control Room: is the nerve center of the operation were the maintenance checks are conducted (remotely or at the site location). The production of electricity is controlled within this room.

16. Master Fan and Carbon Monoxide Filter Room: is located in a room with its own function for the purpose of maintenance and observation of the carbon filters.

17. The Roof: covers the entire upper level work area. The stations are equipped with overhead roll-up doors that extend down to the top of Reinforce Concrete Wall (Item #10) for total enclosure during severe weather conditions.

18. Station Stabilizers: (sheet 5 of 6) are designed to make the wind collector shells rigid. This is achieved by installing stabilizers across the shell in a ninety-degree angle (90°). In addition, the shell's seams are attached to the Wind Collector Buttress (Item #19) that is anchored into the ground. (See Item #6) REFORM Energy Operational System, Description of the drawing.

19. Wind Collector Buttresses: is located in a outer position of the shell to stabilize the station as shown on (Item #6) REFORM Energy Operational System, Description of drawing.

20. Station Monorail: has a hoist that is used for the maintenance and replacement of equipment. This is controlled from the Lift Control Panel Room (Item #14).

This concludes the functions and the operation of my invention for REFORM Energy Systems.

What I claim as my reform energy system invention:

1. The Woods Wind Collector (A, B, C, D, and E) will capture the energy that is produce by vehicular motion.

2. The capture energy will speed-up inside the ducts by reducing the duct size from the wind collectors and the wind cylinder. Also, the draft inside of the cylinder assembly acts as a suction mechanism that pulls the captured wind energy from the wind collectors, thus creating a wind tunnel.

3. The Wind Cylinder Assembly (sheet 2 of 6) is a series of pipes that is reduced from a ten foot diameter (10 ft. dia.) to a eight foot diameter (8 ft. dia.) within a ten foot distance. The winds speed is increased impact of the slave fan blades to produce a greater wind speed that will power the generator gearbox to produce electricity.

4. The Master Fan pushes and pulls the captured energy from one cylinder to another to complete the wind energy cycle inside the wind cylinder. The carbon filter will assist in cleaning the air inside the wind cylinder assembly before its escape into earth's atmosphere.

5. The Slave Fans will rotate, thus spinning the flywheel and the shaft of gearbox from the wind produced from the master fan and the wind collectors inside the wind cylinder assembly.
